(19) United States
(12) Patent Application Publication
(10) Pub. No.: US 2016/0349918 A1
(43) Pub. Date: Dec. 1, 2016

(54) CALIBRATION FOR TOUCH DETECTION ON PROJECTED DISPLAY SURFACES

(71) Applicant: INTEL CORPORATION, Santa Clara, CA (US)

(72) Inventors: Kedar A. Dongre, Hillsboro, OR (US); Vinay K. Nooji, Hillsboro, OR (US); Brandon Gavino, Beaverton, OR (US); David R. Holman, Brampton (CA)

(73) Assignee: INTEL CORPORATION, Santa Clara, CA (US)

(21) Appl. No.: 14/726,227

(22) Filed: May 29, 2015

(51) Int. Cl. G06F 3/041; G06F 3/042

(52) U.S. Cl. CPC G06F 3/0418; G06F 3/0421

(57) ABSTRACT

Techniques for calibrating touch detection devices are described herein. A method for calibrating touch detection may include detecting, via a processor, predefined calibration points from a projected predefined pattern based on visible image sensor data. The method may also include generating, via the processor, a surface depth model by fitting a surface plane to depth sensor data. The method may further include mapping, via the processor, the detected calibration points to surface depth coordinates. The method may also further include mapping, via the processor, an infrared image from infrared (IR) sensor data to the surface depth model using preconfigured image correlations.

### TECHNICAL FIELD

The present invention relates generally to calibration and touch detection. More specifically the present invention relates to techniques for calibrating sensors for touch detection on a projected display surface.

### BACKGROUND

Projected display based computing enables computing experiences on any projected display surface such as a table-top surface. A projected display system may use a projector and various sensors to sense touch on the projected display surface.

### BRIEF DESCRIPTION OF THE DRAWINGS

FIG. 1 is a block diagram illustrating an example computing device that can be used for calibrating and operating a touch detection system;

FIG. 2 is a side view of an example system providing for touch detection according to the techniques described herein;

FIG. 3 is a block diagram of an example method providing calibration and touch detection according to the techniques described herein;

FIG. 4 is a process flow diagram illustrating an example method that depicts calibration of a touch detection system;

FIG. 5 is a process flow diagram illustrating an example method that depicts touch detection; and

FIG. 6 is a block diagram showing computer readable media that store code for calibration and operation of a touch detection system.

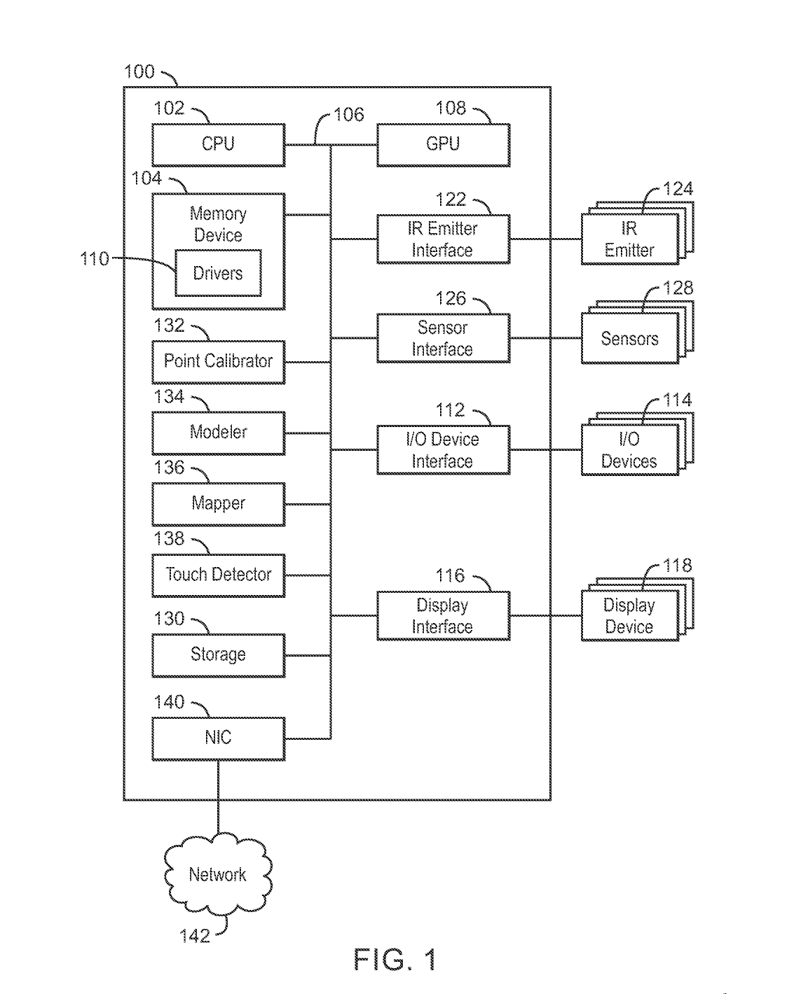

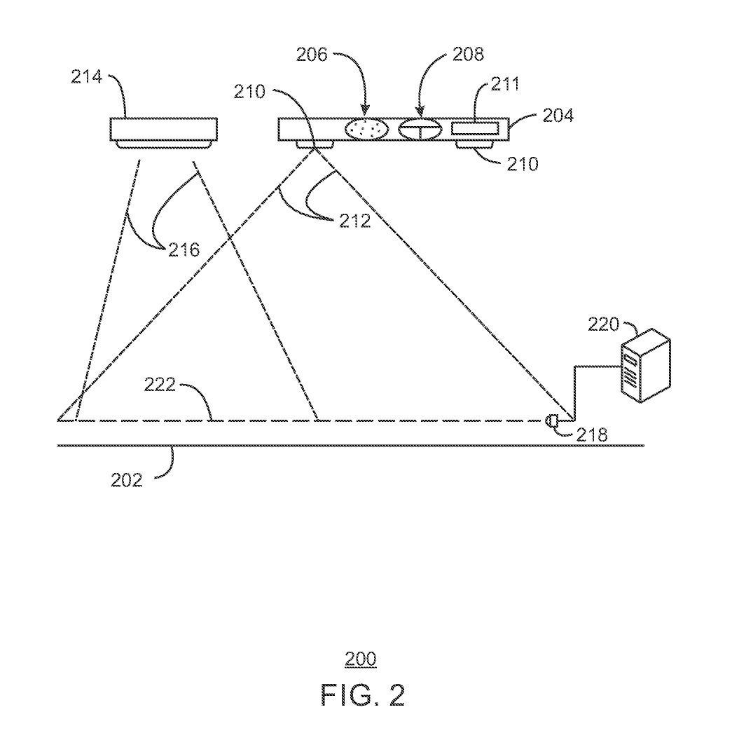

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, the term “occlusion” refers to the limited visibility that a sensor may have of target object due to the presence of at least one object between the sensor and the target object. “Intrinsic parameters” as used herein, refers to focal length, image sensor format, principal point, and lens distortion, or any combination thereof. “Extrinsic parameters” refers to the position of a camera center, a camera's heading in world coordinates, or any combination thereof. Visible image data, also referred to as visible image sensor data, refers to data that is captured by a light sensor that can sense visible light, such as a color camera. Depth data, also referred to as depth sensor data, refers to data that is generated by depth sensors, such as those found in a depth camera. Infrared (IR) data, also referred to as infrared sensor data or an infrared image, refers to data captured by IR sensors.

Techniques for calibrating and operating a touch detection system are provided herein. The techniques herein relate to computer vision, camera technologies, and physical user interfaces. A touch detection system can include a projector to project a display onto a projected display surface and one or more surface infrared (IR) emitters to generate a surface IR plane that is substantially parallel to a projected display surface. The system can also include a visible image sensor to generate visible image sensor data, at least one IR sensor to generate IR sensor data, and a depth sensor to generate depth sensor data from the IR sensor data. The system can be calibrated by mapping between the display coordinates, the visible image sensor coordinates, depth sensor coordinates, and the IR sensor coordinates. For example, the projector may be configured to project a predefined pattern onto a projected display surface via the projector. A processor can read the visible image data to detect predefined calibration points from the projected predefined pattern. The processor can then read the depth sensor data to receive depth image data and generate a surface depth model by fitting a surface plane to the depth image data. The processor can then map the detected calibration points to surface depth coordinates. The processor can also read the infrared sensor data to receive an infrared image corresponding to the infrared sensor data and map the infrared image to the surface depth model using preconfigured image correlations. The processor can then store the mapped calibration points, the mapped infrared image, and the surface depth model in a storage device.

In some examples, the mapped calibration points, mapped infrared image, and surface depth model can also be used to improve touch detection after calibration. For example, the processor can read the infrared image from the IR sensor data and detect potential touch points based on IR plane breaks in the infrared image. The processor can then read the depth sensor data to receive depth data points and evaluate each depth data point to detect touch zone points. The processor can then translate the detected potential touch point to a corresponding depth model coordinate and detect a valid touch based on overlapping touch zone point and potential touch point. The processor can then translate the valid touch to a corresponding display coordinate. In some examples, if the processor does not detect any valid touch based on overlapping depth data and IR touch points, the processor can detect a fingertip touch on the surface based on convex hull and convexity defect detection in the depth data and the fingertip touch can be declared as a valid touch instead. In some examples, the processor can disregard the IR touch points if no fingertip touch or valid touch is detected.

Thus, techniques described herein provide a flexible system and method for detecting touches in a projected display system. The present techniques enable users to use such systems without user calibration or special equipment for calibration. Moreover, the present techniques address technical issues of occlusion and false touch detection due to surface objects by combining data from different sensor sources. Thus, the touch detection system of the present techniques is more accurate than a touch detection system that uses only depth sensor data. Finally, the present techniques allow for a user adjustable projection distance, as the system can be automatically recalibrated after the adjustment.

Some embodiments may be implemented in one or a combination of hardware, firmware, and software. Some embodiments may also be implemented as instructions stored on a computer readable medium, which may be read and executed by a computing platform to perform the operations described herein. A computer readable medium may include any mechanism for storing or transmitting information in a form readable by a machine, e.g., a computer. For example, a computer readable medium may include read only memory (ROM); random access memory (RAM); magnetic disk storage media; optical storage media; flash memory devices; or the interfaces that transmit and/or receive signals, among others.

An embodiment is an implementation or example. Reference in the specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the inventions. The various appearances of “an embodiment”, “one embodiment or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram illustrating an example computing device that can be used for calibrating and operating a touch detection system. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU 102 may be coupled to the memory device 104 by a bus 106. Additionally, the CPU 102 can be a single core processor, a multi-core processor, a computing cluster, or any number of other configurations. Furthermore, the computing device 100 may include more than one CPU 102. The memory device 104 can include random access memory (RAM), read only memory (ROM), flash memory, or any other suitable memory systems. For example, the memory device 104 may include dynamic random access memory (DRAM).

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100.

The memory device 104 can include random access memory (RAM), read only memory (ROM), flash memory, or any other suitable memory systems. For example, the memory device 104 may include dynamic random access memory (DRAM). The memory device 104 may include device drivers 110 that are configured to execute the instructions for calibration and touch detection. The device drivers 110 may be software, an application program, application code, or the like.

The CPU 102 may also be connected through the bus 106 to an input/output (I/O) device interface 112 configured to connect the computing device 100 to one or more I/O devices 114. The I/O devices 114 may include, for example, a keyboard and a pointing device, wherein the pointing device may include a touchpad or a touchscreen, among others. The I/O devices 114 may be built-in components of the computing device 100, or may be devices that are externally connected to the computing device 100. In some examples, the memory 104 may be communicatively coupled to I/O devices 114 through direct memory access (DMA).

The CPU 102 may also be linked through the bus 106 to a display interface 116 configured to connect the computing device 100 to a display device 118. The display device 118 may include a display screen that is a built-in component of the computing device 100. The display device 118 may also include a computer monitor, television, or projector, among others, that is internal to or externally connected to the computing device 100. For example, a primary projector may project a visible image onto a projected display surface for a user to interact with.

The CPU 102 may also be linked through the bus 106 to an IR emitter interface 122 configured to connect the computing device 100 to IR emitters 124. The IR emitters 124 can include a depth IR emitter and a surface IR emitter. For example, the depth IR emitter can project infra-red light onto a surface. The surface IR emitter can project light substantially parallel to the surface. For example, the surface IR emitter can generate a surface IR plane that can be used to detect touch.

The CPU 102 may also be linked through the bus 106 to a sensor interface 126 configured to connect the computing device 100 to sensors 128. The sensors 128 may include a visible image sensor, infrared sensors, and a depth sensor, among others. For example, the visible image sensor can be included in a color camera. The infrared sensors can detect reflected infra-red light generated by the IR emitter 124. The infrared sensors can include two or more infrared sensors spaced apart at a preset distance. A depth sensor can be a separate hardware module that reads the IR light from one or more infrared sensors. The depth sensor can analyze infrared images and compute disparities to generate depth data information. In some examples, the depth sensor can be configured to work in a single sensor depth sensing configuration, also referred to as time-of-flight systems, that can use a sonar emitter instead of infrared light emitter.

The computing device also includes a storage device 120. The storage device 120 is a physical memory such as a hard drive, an optical drive, a thumbdrive, an array of drives, or any combinations thereof. The storage device 120 may also include remote storage drives. The storage device 120 includes a point calibrator 132, a modeler 134, a mapper 136, and a touch detector 138. Components such as the calibrator 132, a modeler 134, a mapper 136, and a touch detector 138 and the like may be logic, at least partially comprising hardware logic. For example, the calibrator 132, a modeler 134, a mapper 136, and a touch detector 138 may be electronic circuitry logic, firmware of a microcontroller, and the like.

In any case, the point calibrator 132 can determine calibration points based on a projected predefined pattern from the visible image data. The modeler 134 can generate a surface depth model by fitting a surface plane to the depth sensor data. The mapper 136 may be configured to map the determined calibration points to surface depth coordinates. The mapper 136 may also be configured map the infrared image to the surface depth model using preconfigured image correlations.

In some cases, a touch detector 138 can detect a touch on a projected display surface using the mapped calibration points, the mapped infrared image, and the surface depth model. For example, the touch detector 138 can detect an IR plane break in the infrared image and evaluate depth data points from the depth sensor data to detect an IR touch point. The touch detector 138 can also map the detected IR touch point to a corresponding depth model coordinate and detect a valid touch based on overlapping depth data and IR touch points. In some examples, the touch detection application can disregard the potential touch point if no fingertip touch or valid touch is detected.

In some examples, the touch detector 138 can also map the valid touch to a corresponding display coordinate. In some examples, the touch detector 138 can send the display coordinate to an application as an input. In some examples, the touch detector can detect the IR touch point based on a projection of the depth data point on to the surface plane and using surface plane coefficients and a normal from the surface depth model. In some examples, if the touch detector 138 does not detect any valid touch based on overlapping depth data and IR touch points, the touch detector 138 can detect a fingertip touch on a projected display surface based on convex hull and convexity defect detection in the depth data and the fingertip touch can be declared as a valid touch instead.

The touch detector 138 can also disregard the IR touch points if no fingertip touch or valid touch is detected. In some examples, the mapper 136 can map the infrared image to the surface depth model by using the preconfigured image correlations to find a corresponding pixel in the infrared image and associate an approximate depth value at that location in the surface depth model. In some examples, the mapper 136 can map the detected calibration points to the surface depth coordinates using preconfigured intrinsic and extrinsic parameters. The mapper 136 can also convert each depth coordinate into a corresponding coordinate of visible image data and find a closest point to establish a mapping between the detected calibration point and the surface depth coordinate.

The computing device 100 may also include a network interface controller (NIC) 140. The NIC 140 may be configured to connect the computing device 100 through the bus 106 to a network 142. The network 142 may be a wide area network (WAN), local area network (LAN), or the Internet, among others. In some examples, the device may communicate with other devices through a wireless technology. For example, Bluetooth® or similar technology may be used to connect with other devices.

The block diagram of FIG. 1 is not intended to indicate that the computing device 100 is to include all of the components shown in FIG. 1. Rather, the computing system 100 can include fewer or additional components not illustrated in FIG. 1, such as sensors, power management integrated circuits, additional network interfaces, and the like. The computing device 100 may include any number of additional components not shown in FIG. 1, depending on the details of the specific implementation. Furthermore, any of the functionalities of the CPU 102 may be partially, or entirely, implemented in hardware and/or in a processor. For example, the functionality of the point calibrator 132, the modeler 134, the mapper 136, and the touch detector 138 may be implemented with an application specific integrated circuit, in logic implemented in a processor, in logic implemented in a specialized graphics processing unit, or in any other device.

FIG. 2. illustrates a side view of an example system providing for touch detection according to the techniques described herein. The system 200 can be implemented on example computing device 102 of FIG. 1.

As discussed above in regard to FIG. 1, sensors 128 may include cameras such as a visible image sensor and a depth sensor, among others such as IR sensors. In FIG. 2, the example system 200 includes a depth camera 204 including a depth IR emitter 206 and visible image sensor 208. The depth camera 204 also includes two IR sensors 210. Both of the IR sensors 210 are shown sensing reflected IR light as indicated by dotted lines 212. The IR sensors 210 may be communicatively coupled to a depth sensor 211 within depth camera 204. In some examples, the depth sensor 211 can be an additional hardware component that uses the images captured by both of the IR sensors to compute disparity and derive depth. For example, based on the disparity of a particular point as captured in two infrared images, the depth sensor 211 can calculate a depth at that particular point. The system 200 also includes a projector 214 that is shown projecting a display as shown by dotted lines 216 onto the projected display surface 202. The system 200 further includes a surface IR emitter 218 that is shown connected to computing device, such as the computing system 100 of FIG. 1. The IR emitter 218 is configured to project a surface IR plane as shown by dotted line 222.

In the example system 200, an automated calibration can be performed. The projector 214 can project a predefined pattern onto the projected display surface 202. In some examples, the predefined pattern can be any pattern that can be preset during manufacture. For example, the pattern can be four dots indicating the mapped corners of a projection display. The visible image sensor 208 can capture a visible image of the predefined pattern on the projected display surface 202. The visible image sensor coordinates can then be mapped to the display projector coordinates based on the predefined pattern and the captured image.

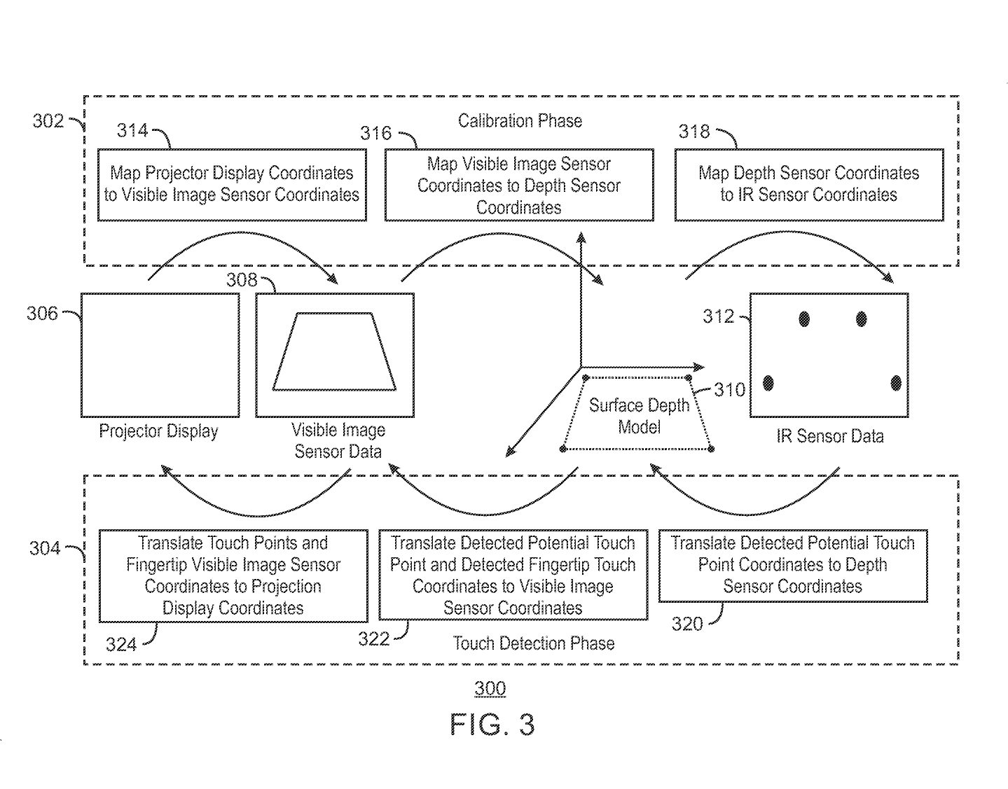

In FIG. 2, once the calibration point coordinates from the projection display 216 are identified in the captured visible image, the computing device 220 can then calibrate the depth sensor 211 with the visible image sensor, as discussed in more detail below in regard to FIG. 3. For example, data 204 gathered from the depth sensor 211 can be read and a depth model can be generated by fitting a surface plane to the received depth sensor information. The infrared sensors 210 can detect infrared light points emitted by one or more depth IR emitters 206 and the depth sensor 211 can determine the depth at the infrared light points. These depth points can then be expressed in the form of a surface plane. For example, the surface plane can be expressed in the general form by the equation: ax+by+cz+d=0, where a nonzero normal vector n to the plane can be expressed as: n=(a, b, c). The calibration points from the captured visible image can then be mapped to corresponding surface depth coordinates using preconfigured intrinsic and extrinsic parameters for the depth camera 204. For example, the intrinsic and extrinsic parameters may have been preconfigured during manufacture of the depth camera 204. In some examples, the mapping can be accomplished by converting each depth coordinate to a corresponding visible image sensor coordinate and finding the closest point in the visible image sensor coordinate system for mapping.

In some examples, the infrared sensor data can then be read and the surface depth model mapped to corresponding points in an infrared image. For example, after infrared images are captured by the infrared sensors, the depth sensor 211 can use the captured infrared images to generate depth information that can include a depth image. In some examples, preconfigured image correlations can be used to find corresponding pixels in the depth image and approximate depth values can be associated at those locations. For example, image correlations may be defined during manufacture that can be used to align the depth information and the infrared emitter with one of the infrared sensors. Once the depth image and infrared images are aligned, then depth values in the infrared images can generated by accessing corresponding pixel locations in the depth image.

The diagram of FIG. 2 is not intended to indicate that the example system 200 is to include all of the components shown in FIG. 2. Rather, the example system 200 can include fewer or additional components not illustrated in FIG. 2 (e.g., additional sensors, cameras, projectors, IR emitters, etc.).

FIG. 3. is a block diagram of an example method providing calibration and touch detection according to the techniques described herein. In FIG. 3, the example method 300 includes a calibration phase 302 and a touch detection phase 304. The calibration phase 302 and a touch detection phase 304 are illustrated using a projector display 306, visible image sensor data 308, surface depth model 310, and IR sensor data 312. The projector display 306 shows a pattern to be displayed by a projector, such as the projector 214 of FIG. 2. The visible image sensor data 308 shows the projector display 306 as captured by a visible image sensor as reflected off a projected display surface. The surface depth model 310 shows a three dimensional model including the four mapped corners of the captured projector display 306 along a plane. The IR sensor data 312 illustrates an infrared image of the projector display, in particular, four dots representing the mapped corners of the projector display 306.

In the example system 300, the calibration phase can begin at block 314, wherein the system can map coordinates of the projector display 306 to coordinates of the visible image sensor 308. For example, the projector display may be projected at a particular resolution and angle. The visible image sensor may capture images at a particular resolution and angle as well. In some examples, in order to map the projector display coordinates to the visible image sensor coordinates, predefined calibration points can be included in the projector display. For example, the four corners of the projector display bounds can be used as predefined calibration points. A visible image sensor, such as the image sensor 208 of FIG. 2, can capture a visible image of the projector display and the processor can receive the visible image data including the visible image. For example, the visible image can be a color picture including red, blue, and green (RGB) data.

At block 316, the system can map the coordinates of the visible image sensor 208 to coordinates of a depth sensor 211. For example, a depth model can be generated by fitting a surface plane to captured depth sensor data. The coordinates gathered by the visible image sensor 208 can then be mapped to corresponding surface depth coordinates using preconfigured intrinsic and extrinsic parameters. For example, each depth coordinate can be converted into a corresponding visible image sensor coordinate using the parameters and the closest visible image sensor coordinate point can be found to establish the mapping.

At block 318, the coordinates detected by the depth sensor 211 can be mapped to the IR sensor coordinates. For example, the surface depth model can be mapped to an infrared image corresponding to IR sensor data. In some examples, preconfigured image correlations can be used to find a pixel in the infrared image corresponding to a point on the surface depth model image and an approximate depth value can then be associated at that location.

In some examples, the coordinate mappings and the surface depth model can be stored to a storage device, such as the storage device 130 of FIG. 1. In some cases, the surface depth model can be stored as a persistent storage file to be used in the touch detection phase 304. Automatic calibration is thus accomplished by detecting calibration points using the visible image sensor 208 and then mapping the calibration points to corresponding coordinates of the depth sensor 211 and the infrared image of infrared sensors 210. Thus, a user does not perform any calibration saving users time and efforts. Nor is any specialized material or equipment used during the calibration process, which enables a more efficient calibration process.

After the calibration phase 302 is complete, the touch detection phase 304 can begin with block 320. At block 320, the coordinates of detected potential touch point can be mapped to corresponding depth sensor coordinates. For example, an infrared image from an IR sensor can be received and one or more potential touch points can be detected by detecting IR plane breaks within the infrared image. The IR sensor coordinates of the IR plane breaks can be translated to depth sensor coordinates using the mapping created in block 318 above. In some examples, the potential touch points can be evaluated against detected touch zone points to detect valid touch points. For example, touch zone points can be identified from depth sensor data points that fall within a touch zone between 0 mm and 5 mm from the projected display surface.

At block 322, the depth sensor coordinates of the detected potential touch points and the detected fingertip touches can be translated to corresponding visible image sensor coordinates. For example, the mapping generated at block 316 can be used to translate from depth sensor coordinates to visible image sensor coordinates. In some examples, the visible image sensor coordinates can be RGB coordinates.

Still referring to FIG. 3, after valid touch points are detected and fingertip touches are detected, at block 324 the coordinates of the detected valid touch points and fingertip touches can be translated to projection display coordinates. The projection display coordinates can then be used by the system as input into one or more applications.

The diagram of FIG. 3 is not intended to indicate that the example system 300 is to include all of the components shown in FIG. 3. Rather, the example classification systems 300 can include fewer or additional components not illustrated in FIG. 3 (e.g., additional phases, mappings, images, etc.).

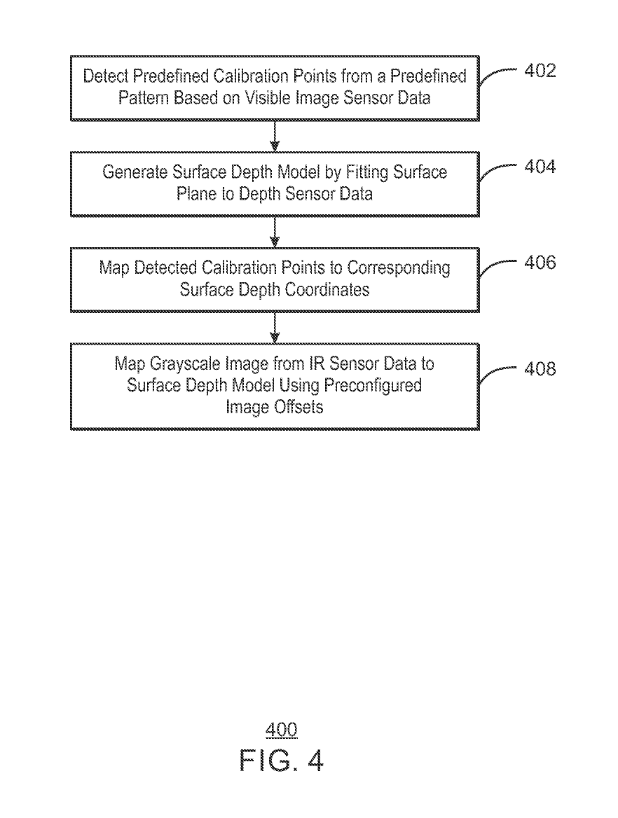

FIG. 4 is a process flow diagram illustrating an example method that depicts calibration of a touch detection system. The example method of FIG. 4 is generally referred to by the reference number 400 and is discussed with reference to FIG. 1.

At block 402, a point calibrator 132 can detect predefined calibration points from a predefined pattern based on visible image sensor data. For example, the point calibrator 132 can have a projector 118 project a predefined pattern on a projected display surface. The point calibrator 132 can read visible image sensor data to detect predefined calibration points from the predefined pattern.

At block 404, a modeler 134 generates a surface depth model by fitting a surface plane to the depth sensor data. For example, the depth sensor data can be received from one or more IR sensors, such as the IR sensors 210 found in depth camera 204 referred to above in regard to FIG. 2.

At block 406, a mapper 136 maps detected calibration points to corresponding surface depth coordinates. For example, the mapper 136 can map the detected calibration points to the corresponding surface depth coordinates based on factory preconfigured intrinsic and extrinsic parameters. In some examples, each depth coordinate can be converted into a corresponding visible image coordinate and the closest visible image coordinate can be used to establish the mapping.

At block 408, the mapper 136 maps an infrared image from IR sensor data to a surface depth model using preconfigured image correlations. The mapper 136 can read infrared sensor data to receive an infrared image. For example, the infrared image can correspond to the IR plane emitted by a surface IR emitter.

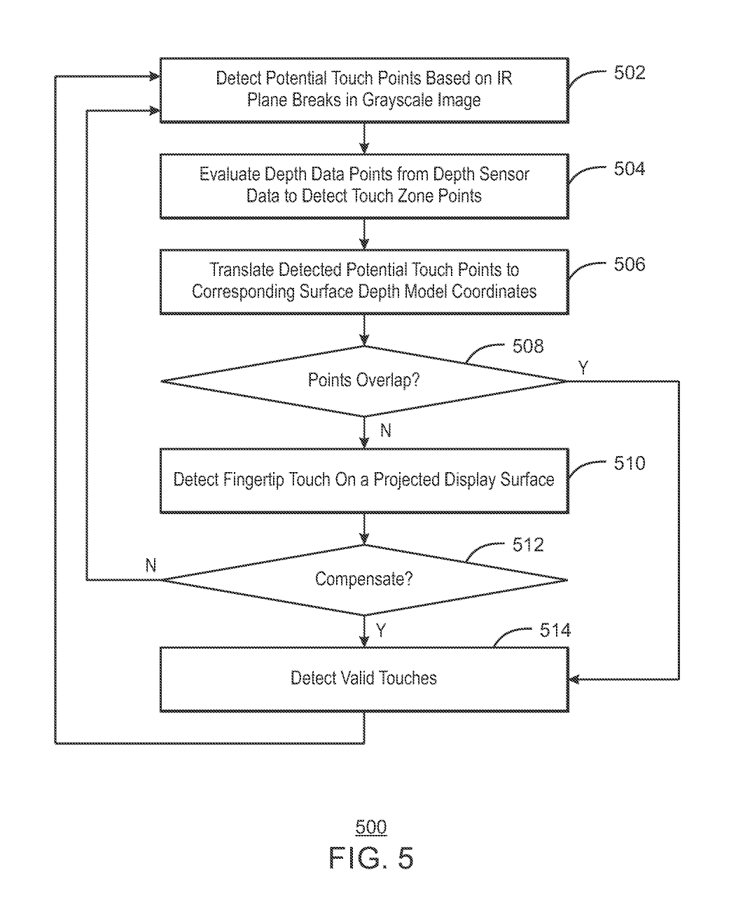

In some examples, the mapper 136 can store the mapped calibration points, the mapped infrared image, and the surface depth model. In some examples, the mapped calibration points, mapped infrared image, and surface depth model can be saved to storage 130 for later use. For example, the mapped calibration points, mapped infrared image, and surface depth model can be used in touch detection as described in greater detail with respect to FIG. 5 below.

This process flow diagram is not intended to indicate that the blocks of the method 400 are to be executed in any particular order, or that all of the blocks are to be included in every case. Further, any number of additional blocks not shown may be included within the method 400, depending on the details of the specific implementation.

FIG. 5 is a process flow diagram illustrating an example method that depicts touch detection. The example method of FIG. 5 is generally referred to by the reference number 500 and is discussed with reference to FIG. 1.

At block 502, the touch detector 138 detects potential touch points based on IR plane breaks in an infrared image. For example, one or more objects may block the infrared light emitted from a surface IR emitter. In some examples, the objects can be at least partially opaque. The infrared image captured by one or more IR sensors can thus include plane breaks created by the objects blocking the infrared light emitted from the surface IR emitter.

At block 504, the touch detector 138 evaluates depth data points from depth sensor data to detect touch zone points. A touch zone point can be detected if the depth sensor data indicates a point that falls within a preconfigured touch zone. For example, the touch zone can be preconfigured to be 0 mm to 5 mm from the projected display surface. In some examples, the depth data point can be projected onto a surface plane and the surface plane coefficients and normal computed at method 400 above can be used to evaluate the depth data point.

At block 506, the touch detector 138 translates detected potential touch points to corresponding surface depth model coordinates. For example, the mapping created in block 408 of method 400 can be used to translate the detected potential touch points from the IR sensor data to coordinates of the surface depth model. In some examples, the touch detector 138 can translate the detection potential touch points based on an approximate depth value at each pixel and preconfigured intrinsic parameters of the visible image sensor. For example, the touch detector 138 can convert a potential touch point to a depth model coordinate. The depth model coordinate can include X/Y/Z vector values describing a 3D vector to the potential touch point. Once the touch detector 138 generates the 3D vector in depth model coordinate system, the touch detector 138 can use a surface normal and plane coefficients to compute the distance to the plane in the surface depth model.

At block 508, the touch detector 138 determines if the potential touch points and the touch zone points overlap. For example, the depth model coordinates of the potential touch points and the touch zone points can be compared. If any of the potential touch points overlap with any of the touch zone points, then the process can proceed to block 514.

At block 510, the touch detector 138 detects fingertip touch on a projected display surface. For example, the touch detector 138 can detect a fingertip touch on a projected display surface if no valid touch is detected based the potential touch point overlapping one of the touch zone points. In some examples, the touch detector 138 can detect a fingertip touch based on convex hull detection. For example, the touch detector 138 can find a closed contour shape in the depth data that contains all convex points. In some examples, the touch detector 138 can detect a fingertip touch based on convexity defect detection. For example, the touch detector 138 can find points that are furthest away from each convex vertex. In some examples, the combination of a convex hull shape containing convexity defects can be used to detect the shape of the hand and thus the presence of hand and finger tips.

At block 512, the touch detector 138 determines whether to compensate based on the detected fingertip touch. For example, if no overlapping potential touch points and touch zone points are detected, then the touch detector 138 can use detected fingertip touches instead. In some examples, the touch detector 138 can disregard the potential touch point if no fingertip touches or other valid touches are detected.

At block 514, the touch detector 138, detects valid touches. For example, the valid touches can be based on overlapping touch zone points and potential touch points and translates the valid touches to corresponding display coordinates. In some examples, a detected fingertip touch can compensate for lack of overlapping touch zone points and potential touch points and can be treated as a detected valid touch. The touch detector 138 can translate the coordinates of the valid touches using an approximate depth value at each pixel and preconfigured intrinsic parameters of the visible image sensor. In some examples, the touch detector 138 can then send the display coordinates to an application as an input.

This process flow diagram is not intended to indicate that the blocks of the method 500 are to be executed in any particular order, or that all of the blocks are to be included in every case. Further, any number of additional blocks not shown may be included within the method 500, depending on the details of the specific implementation.

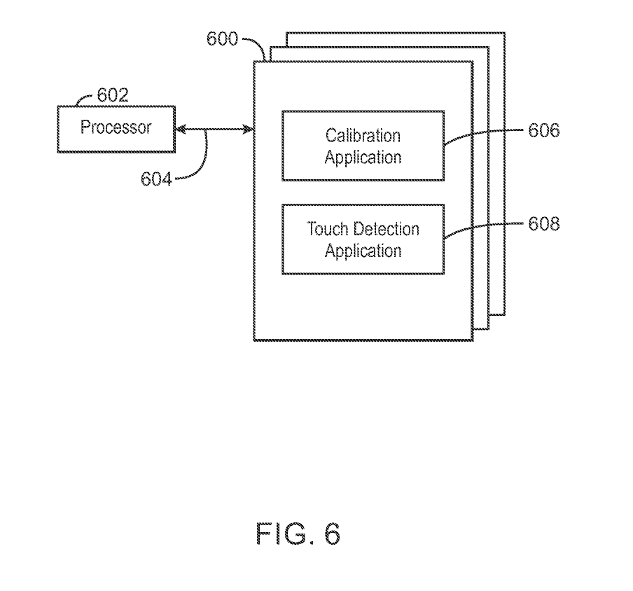

FIG. 6 is a block diagram showing computer readable media 600 that store code for calibration and operation of a touch detection system. The computer readable media 600 may be accessed by a processor 602 over a computer bus 604. Furthermore, the computer readable medium 600 may include code configured to direct the processor 602 to perform the methods described herein. In some embodiments, the computer readable media 600 may be non-transitory computer readable media. In some examples, the computer readable media 600 may be storage media. However, in any case, the computer readable media do not include transitory media such as carrier waves, signals, and the like.

The block diagram of FIG. 6 is not intended to indicate that the computer readable media 600 is to include all of the components shown in FIG. 6. Further, the computer readable media 600 may include any number of additional components not shown in FIG. 6, depending on the details of the specific implementation.

The various software components discussed herein can be stored on one or more computer readable media 600, as indicated in FIG. 6. For example, a calibration application 606 can be configured to detect predefined calibration points based on a projected predefined pattern from visible image sensor data. In some examples, the calibration application 606 can generate a surface depth model by fitting a surface plane to the depth sensor data. The calibration application 606 can map the detected calibration points to surface depth coordinates. The calibration application 606 can also map an infrared image from infrared (IR) sensor data to the surface depth model using preconfigured image correlations.

A touch detection application 608 can be configured to detect a touch of a display surface using the mapped calibration points, the mapped infrared image, and the surface depth model. In some examples, the touch detection application 608 can also be configured to detect a potential touch based on an IR plane break in the infrared image. In some examples, the touch detection application 608 can also evaluate depth data points from depth sensor data to detect one or more touch zone points. In some examples, the touch detection application 608 can also translate the detected potential touch point to a corresponding depth model coordinate. For example, the touch detection application 608 can translate the detected potential touch point to the corresponding depth model coordinate using an approximate depth value at each pixel and preconfigured intrinsic parameters of the visible image sensor. In some examples, the touch detection application 608 can also detect a valid touch based on the potential touch point overlapping one of the touch zone points. In some examples, the touch detection application 608 can also translate the valid touch to a corresponding display coordinate. In some examples, the touch detection application 608 can detect a fingertip touch on a projected display surface based on convex hull or convexity defect detection if no valid touch is detected based on the potential touch point overlapping one of the touch zone points. In some examples, the touch detection application can disregard the potential touch point if no fingertip touch or valid touch is detected.

The block diagram of FIG. 6 is not intended to indicate that the computer readable media 600 is to include all of the components shown in FIG. 6. Further, the computer readable media 600 can include any number of additional components not shown in FIG. 6, depending on the details of the specific implementation.

Example 1 is an apparatus for projected display surface calibration. The apparatus includes one or more surface emitters. The apparatus also includes one or more sensors to capture visible image data, depth data, and infrared data associated with an infrared image. The apparatus also include a point calibrator to detect calibration points based on a projected predefined pattern from the visible image data. The apparatus further includes a modeler to generate a surface depth model by fitting a surface plane to the depth data. The apparatus also further includes a mapper to map the detected calibration points to surface depth coordinates of the surface depth model. The mapper can also map the infrared image to the surface depth model based on preconfigured image correlations.

Example 2 incorporates the subject matter of Example 1. In this example, the apparatus further includes a touch detector configured to detect a touch on a projected display surface based on the mapped calibration points, the mapped infrared image, and the surface depth model.

Example 3 incorporates the subject matter of any combination of Examples 1-2. In this example, the apparatus further includes a touch detector configured to detect a potential touch point based on an infrared plane break in the infrared image. Additionally, the touch detector is configured to evaluate depth data points from the depth data to detect one or more touch zone points. Additionally, the touch detector is configured to translate the detected potential touch point to a corresponding surface depth model coordinate. Additionally, the touch detector is configured to detect a valid touch based on the potential touch point overlapping one of the touch zone points. Additionally, the touch detector is configured to translate the valid touch to a corresponding display coordinate.

Example 4 incorporates the subject matter of any combination of Examples 1-3. In this example, the touch detector is further configured to send the display coordinate to an application as an input.

Example 5 incorporates the subject matter of any combination of Examples 1-4. In this example, the touch detector is further configured to translate the detected potential touch point to the corresponding depth model coordinate based on an approximate depth value at each pixel and preconfigured intrinsic parameters of the visible image sensor.

Example 6 incorporates the subject matter of any combination of Examples 1-5. In this example, the touch detector is further configured to detect a fingertip touch on a projected display surface based on convex hull detection and convexity defect detection if no valid touch is detected based on the potential touch point overlapping one of the touch zone points.

Example 7 incorporates the subject matter of any combination of Examples 1-6. In this example, the touch detector is further configured to disregard the potential touch point if no fingertip touch or valid touch is detected.

Example 8 incorporates the subject matter of any combination of Examples 1-7. In this example, mapping the infrared image to the surface depth model includes determining a corresponding pixel in the infrared image based on the preconfigured image correlations and associating an approximate depth value at the corresponding location in the surface depth model.

Example 9 incorporates the subject matter of any combination of Examples 1-8. In this example, the mapper is further configured to map the detected calibration points to the surface depth coordinates based on preconfigured intrinsic and extrinsic parameters.

Example 10 incorporates the subject matter of any combination of Examples 1-9. In this example, the mapper is further configured to convert each surface depth coordinate into a corresponding coordinate of the visible image data and find a closest point to establish a mapping between the detected calibration point and the surface depth coordinate.

Example 11 is a method for calibrating a touch detection device. The method includes detecting, via a processor, predefined calibration points based on a projected predefined pattern from visible image sensor data. The method also includes generating, via the processor, a surface depth model by fitting a surface plane to depth sensor data. The method further includes mapping, via the processor, the detected calibration points to surface depth coordinates. The method further also includes mapping, via the processor, an infrared image from infrared sensor data to the surface depth model based on preconfigured image correlations.

Example 12 incorporates the subject matter of Example 11. In this example, the method includes detecting a touch of a projected display surface based on the mapped calibration points, the mapped infrared image, and the surface depth model.

Example 13 incorporates the subject matter of any combination of Examples 11-12. In this example, the method includes detecting, via the processor, a potential touch based on an infrared plane break in the infrared image. The method further includes evaluating, via the processor, depth data points from depth sensor data to detect one or more touch zone points. The method further includes translating, via the processor, the detected potential touch point to a corresponding surface depth model coordinate. The method further includes detecting, via the processor, a valid touch based on the potential touch point overlapping one of the touch zone points. The method further includes translating, via the processor, the valid touch to a corresponding display coordinate.

Example 14 incorporates the subject matter of any combination of Examples 11-13. In this example, the method includes sending, via the processor, the display coordinate to an application as an input.

Example 15 incorporates the subject matter of any combination of Examples 11-14. In this example, translating the detected potential touch point to the corresponding depth model coordinate is based on an approximate depth value at each pixel and preconfigured intrinsic parameters of the visible image sensor.

Example 16 incorporates the subject matter of any combination of Examples 11-15. In this example, the method includes detecting, via the processor, a fingertip touch on a projected display surface based on convex hull and convexity defect detection if no valid touch is detected based the potential touch point overlapping one of the touch zone points.

Example 17 incorporates the subject matter of any combination of Examples 11-16. In this example, the method includes disregarding the potential touch point if no fingertip touch or valid touch is detected.

Example 18 incorporates the subject matter of any combination of Examples 11-17. In this example, mapping the infrared image to the surface depth model comprises determining a corresponding pixel in the infrared image based on the preconfigured image correlations and associating an approximate depth value at the corresponding location in the surface depth model.

Example 19 incorporates the subject matter of any combination of Examples 11-18. In this example, mapping the detected calibration points to the surface depth coordinates is based on preconfigured intrinsic and extrinsic parameters.

Example 20 incorporates the subject matter of any combination of Examples 11-19. In this example, the method includes converting, via the processor, each depth coordinate into a corresponding coordinate of visual image data and finding a closest point to establish a mapping between the detected calibration point and the surface depth coordinate.

Example 21 is a computer readable medium for touch detection. The computer readable medium has instructions stored therein that, in response to being executed on a computing device, cause the computing device to detect predefined calibration points based on a projected predefined pattern from visible image sensor data. The computer readable medium also has instructions stored therein causing the computing device to generate a surface depth model by fitting a surface plane to the depth sensor data. The computer readable medium also has instructions stored therein causing the computing device to map the detected calibration points to surface depth coordinates. The computer readable medium also has instructions stored therein causing the computing device to map an infrared image from infrared sensor data to the surface depth model based on preconfigured image correlations. The computer readable medium also has instructions stored therein causing the computing device to detect a touch of a display surface based on the mapped calibration points, the mapped infrared image, and the surface depth model.

Example 22 incorporates the subject matter of Example 21. In this example, the computer readable medium also has instructions stored therein causing the computing device to detect a potential touch based on an infrared plane break in the infrared image. The computer readable medium also has instructions stored therein causing the computing device to evaluate depth data points from depth sensor data to detect one or more touch zone points. The computer readable medium also has instructions stored therein causing the computing device to translate the detected potential touch point to a corresponding surface depth model coordinate. The computer readable medium also has instructions stored therein causing the computing device to detect a valid touch based on the potential touch point overlapping one of the touch zone points. The computer readable medium also has instructions stored therein causing the computing device to translate the valid touch to a corresponding display coordinate.

Example 23 incorporates the subject matter of any combination of Examples 21-22. In this example, the computer readable medium also has instructions stored therein causing the computing device to translate the detected potential touch point to the corresponding depth model coordinate based on an approximate depth value at each pixel and preconfigured intrinsic parameters of an visible image sensor.

Example 24 incorporates the subject matter of any combination of Examples 21-23. In this example, the computer readable medium also has instructions stored therein causing the computing device to detect a fingertip touch on a projected display surface based on convex hull or convexity defect detection if no valid touch is detected based on the potential touch point overlapping one of the touch zone points.

Example 25 incorporates the subject matter of any combination of Examples 21-24. In this example, the computer readable medium also has instructions stored therein causing the computing device to disregard the potential touch point if no fingertip touch or valid touch is detected.

Example 26 incorporates the subject matter of any combination of Examples 21-25. In this example, the computer readable medium also has instructions stored therein causing the computing device to send the display coordinate to an application as an input.

Example 27 incorporates the subject matter of any combination of Examples 21-26. In this example, the computer readable medium also has instructions stored therein causing the computing device to determine a corresponding pixel in the infrared image based on the preconfigured image correlations and associating an approximate depth value at the corresponding location in the surface depth model.

Example 28 incorporates the subject matter of any combination of Examples 21-27. In this example, the computer readable medium also has instructions stored therein causing the computing device to map the detected calibration points to the surface depth coordinates based on preconfigured intrinsic and extrinsic parameters.

Example 29 incorporates the subject matter of any combination of Examples 21-28. In this example, the computer readable medium also has instructions stored therein causing the computing device to project a predefined pattern comprising four dots indicating four mapped corners of a projection display.

Example 30 incorporates the subject matter of any combination of Examples 21-29. In this example, the computer readable medium also has instructions stored therein causing the computing device to convert each surface depth coordinate into a corresponding coordinate of the visible image data and find a closest point to establish a mapping between the detected calibration point and the surface depth coordinate.

Example 31 is a system for projected display surface calibration. The system includes means for emitting infrared light. The system also includes means for sensing visible image data, depth data, and infrared data associated with an infrared image. The system further includes means for detecting calibration points based on a projected predefined pattern from the visible image data. The system further also includes means for generating a surface depth model by fitting a surface plane to the depth data. The system also includes means for mapping the detected calibration points to surface depth coordinates of the surface depth model. The system further includes means for mapping the infrared image to the surface depth model based on preconfigured image correlations.

Example 32 incorporates the subject matter of Example 31. In this example, the system includes means for detecting a touch on a projected display surface based on the mapped calibration points, the mapped infrared image, and the surface depth model.

Example 33 incorporates the subject matter of any combination of Examples 31-32. In this example, the system includes means for detecting a potential touch point based on an infrared plane break in the infrared image. The system also includes means for evaluating depth data points from the depth data to detect one or more touch zone points. The system also further includes means for translating the detected potential touch point to a corresponding surface depth model coordinate. The system also includes means for detecting a valid touch based on the potential touch point overlapping one of the touch zone points. The system further includes means for translating the valid touch to a corresponding display coordinate.

Example 34 incorporates the subject matter of any combination of Examples 31-33. In this example, the system includes means for sending the display coordinate to an application as an input.

Example 35 incorporates the subject matter of any combination of Examples 31-34. In this example, the system includes means for translating the detected potential touch point to the corresponding depth model coordinate based on an approximate depth value at each pixel and preconfigured intrinsic parameters of the visible image sensor.

Example 36 incorporates the subject matter of any combination of Examples 31-35. In this example, the system includes means for detect a fingertip touch on a projected display surface based on convex hull detection and convexity defect detection if no valid touch is detected based on the potential touch point overlapping one of the touch zone points.

Example 37 incorporates the subject matter of any combination of Examples 31-36. In this example, the system includes means for disregarding the potential touch point if no fingertip touch or valid touch is detected.

Example 38 incorporates the subject matter of any combination of Examples 31-37. In this example, the system includes means for determining a corresponding pixel in the infrared image based on the preconfigured image correlations and associating an approximate depth value at the corresponding location in the surface depth model.

Example 39 incorporates the subject matter of any combination of Examples 31-38. In this example, the system includes means for mapping the detected calibration points to the surface depth coordinates based on preconfigured intrinsic and extrinsic parameters.

Example 40 incorporates the subject matter of any combination of Examples 31-39. In this example, the system includes a means for converting each surface depth coordinate into a corresponding coordinate of the visible image data, as well as a means to find a closest point to establish a mapping between the detected calibration point and the surface depth coordinate.

Example 41 is a system for projected display surface calibration. The system includes one or more surface emitters. The system includes one or more sensors to capture visible image data, depth data, and infrared data associated with an infrared image. The system also includes a point calibrator to detect calibration points based on a projected predefined pattern from the visible image data. The system also includes a modeler to generate a surface depth model by fitting a surface plane to the depth data. The system further includes a mapper to map the detected calibration points to surface depth coordinates of the surface depth model. Additionally, the mapper is to map the infrared image to the surface depth model based on preconfigured image correlations.

Example 42 incorporates the subject matter of Example 41. In this example, the system further includes a touch detector configured to detect a touch on a projected display surface based on the mapped calibration points, the mapped infrared image, and the surface depth model.

Example 43 incorporates the subject matter of any combination of Examples 41-42. In this example, the system further includes a touch detector configured to detect a potential touch point based on an infrared plane break in the infrared image. The touch detector is further configured to evaluate depth data points from the depth data to detect one or more touch zone points. The touch detector is also configured to translate the detected potential touch point to a corresponding surface depth model coordinate. The touch detector is further configured to detect a valid touch based on the potential touch point overlapping one of the touch zone points. The touch detector is also configured to translate the valid touch to a corresponding display coordinate.

Example 44 incorporates the subject matter of any combination of Examples 41-43. In this example, the touch detector is further configured to send the display coordinate to an application as an input.

Example 45 incorporates the subject matter of any combination of Examples 41-44. In this example, the touch detector is further configured to translate the detected potential touch point to the corresponding depth model coordinate based on an approximate depth value at each pixel and preconfigured intrinsic parameters of the visible image sensor.

Example 46 incorporates the subject matter of any combination of Examples 41-45. In this example, the touch detector is further configured to detect a fingertip touch on a projected display surface based on convex hull detection and convexity defect detection if no valid touch is detected based on the potential touch point overlapping one of the touch zone points.

Example 47 incorporates the subject matter of any combination of Examples 41-46. In this example, the touch detector is further configured to disregard the potential touch point if no fingertip touch or valid touch is detected.

Example 48 incorporates the subject matter of any combination of Examples 41-47. In this example, mapping the infrared image to the surface depth model includes determining a corresponding pixel in the infrared image based on the preconfigured image correlations and associating an approximate depth value at the corresponding location in the surface depth model.

Example 49 incorporates the subject matter of any combination of Examples 41-48. In this example, the mapper is further configured to map the detected calibration points to the surface depth coordinates based on preconfigured intrinsic and extrinsic parameters.

Example 50 incorporates the subject matter of any combination of Examples 41-49. In this example, the mapper is further configured to convert each surface depth coordinate into a corresponding coordinate of the visible image data and find a closest point to establish a mapping between the detected calibration point and the surface depth coordinate.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus for projected display surface calibration, comprising:
one or more surface emitters;
one or more sensors to capture visible image data, depth data, and infrared data associated with an infrared image;
a point calibrator to detect calibration points based on a projected predefined pattern from the visible image data;
a modeler to generate a surface depth model by fitting a surface plane to the depth data; and
a mapper to map:
the detected calibration points to surface depth coordinates of the surface depth model; and
the infrared image to the surface depth model based on preconfigured image correlations.

2. The apparatus of claim 1, further comprising a touch detector configured to detect a touch on a projected display surface based on the mapped calibration points, the mapped infrared image, and the surface depth model.

3. The apparatus of claim 1, further comprising a touch detector configured to:
detect a potential touch point based on an infrared plane break in the infrared image;
evaluate depth data points from the depth data to detect one or more touch zone points;
translate the detected potential touch point to a corresponding surface depth model coordinate;
detect a valid touch based on the potential touch point overlapping one of the touch zone points; and
translate the valid touch to a corresponding display coordinate.

4. The apparatus of claim 3, wherein the touch detector is further configured to send the display coordinate to an application as an input.

5. The apparatus of claim 3, wherein the touch detector is further configured to translate the detected potential touch point to the corresponding depth model coordinate based on an approximate depth value at each pixel and preconfigured intrinsic parameters of the visible image sensor.

6. The apparatus of claim 3, wherein the touch detector is further configured to detect a fingertip touch on a projected display surface based on convex hull detection and convexity defect detection if no valid touch is detected based on the potential touch point overlapping one of the touch zone points.

7. The apparatus of claim 3, wherein the touch detector is further configured to disregard the potential touch point if no fingertip touch or valid touch is detected.

8. The apparatus of claim 1, wherein mapping the infrared image to the surface depth model comprises determining a corresponding pixel in the infrared image based on the preconfigured image correlations and associating an approximate depth value at the corresponding location in the surface depth model.

9. The apparatus of claim 1, wherein the mapper is further configured to map the detected calibration points to the surface depth coordinates based on preconfigured intrinsic and extrinsic parameters.

10. The apparatus of claim 9, wherein the mapper is further configured to convert each surface depth coordinate into a corresponding coordinate of the visible image data and find a closest point to establish a mapping between the detected calibration point and the surface depth coordinate.

11. A method for calibrating a touch detection device, comprising:
detecting, via a processor, predefined calibration points based on a projected predefined pattern from visible image sensor data;
generating, via the processor, a surface depth model by fitting a surface plane to depth sensor data;
mapping, via the processor, the detected calibration points to surface depth coordinates; and
mapping, via the processor, an infrared image from infrared sensor data to the surface depth model based on preconfigured image correlations.

12. The method of claim 11, further comprising detecting a touch of a projected display surface based on the mapped calibration points, the mapped infrared image, and the surface depth model.

13. The method of claim 11, further comprising:
detecting, via the processor, a potential touch based on an infrared plane break in the infrared image;
evaluating, via the processor, depth data points from depth sensor data to detect one or more touch zone points;
translating, via the processor, the detected potential touch point to a corresponding surface depth model coordinate;
detecting, via the processor, a valid touch based on the potential touch point overlapping one of the touch zone points; and
translating, via the processor, the valid touch to a corresponding display coordinate.

14. The method of claim 13, further comprising sending, via the processor, the display coordinate to an application as an input.

15. The method of claim 13, wherein translating the detected potential touch point to the corresponding depth model coordinate is based on an approximate depth value at each pixel and preconfigured intrinsic parameters of the visible image sensor.

16. The method of claim 13, further comprising detecting, via the processor, a fingertip touch on a projected display surface based on convex hull and convexity defect detection if no valid touch is detected based the potential touch point overlapping one of the touch zone points.

17. The method of claim 16, further comprising disregarding the potential touch point if no fingertip touch or valid touch is detected.

18. The method of claim 11, wherein mapping the infrared image to the surface depth model comprises determining a corresponding pixel in the infrared image based on the preconfigured image correlations and associating an approximate depth value at the corresponding location in the surface depth model.

19. The method of claim 11, wherein mapping the detected calibration points to the surface depth coordinates is based on preconfigured intrinsic and extrinsic parameters.

20. The method of claim 19, further comprising converting, via the processor, each depth coordinate into a corresponding coordinate of visual image data and finding a closest point to establish a mapping between the detected calibration point and the surface depth coordinate.

21. At least one computer readable medium for touch detection having instructions stored therein that, in response to being executed on a computing device, cause the computing device to:
detect predefined calibration points based on a projected predefined pattern from visible image sensor data;
generate a surface depth model by fitting a surface plane to the depth sensor data;
map the detected calibration points to surface depth coordinates;
map an infrared image from infrared sensor data to the surface depth model based on preconfigured image correlations; and
detect a touch of a display surface based on the mapped calibration points, the mapped infrared image, and the surface depth model.

22. The at least one computer readable medium of claim 21, further comprising instructions to:
detect a potential touch based on an infrared plane break in the infrared image;
evaluate depth data points from depth sensor data to detect one or more touch zone points;
translate the detected potential touch point to a corresponding surface depth model coordinate;
detect a valid touch based on the potential touch point overlapping one of the touch zone points; and
translate the valid touch to a corresponding display coordinate.

23. The at least one computer readable medium of claim 22, further comprising instructions to translate the detected potential touch point to the corresponding depth model coordinate based on an approximate depth value at each pixel and preconfigured intrinsic parameters of an visible image sensor.

24. The at least one computer readable medium of claim 22, further comprising instructions to detect a fingertip touch on a projected display surface based on convex hull or convexity defect detection if no valid touch is detected based on the potential touch point overlapping one of the touch zone points.

25. The at least one computer readable medium of claim 24, further comprising instructions to disregard the potential touch point if no fingertip touch or valid touch is detected.
